(19) United States
(12) Patent Application Publication
(10) Pub. No.: US 2026/0111651 A1
(43) Pub. Date: Apr. 23, 2026

(54) DOCUMENT GENERATION SYSTEM AND METHOD

(71) Applicant: Sluice AI, Inc., Austin, TX (US)

(72) Inventors: Rush BARTLETT, Austin, TX (US); Frank WANG, Zhubei City (TW)

(21) Appl. No.: 19/415,020

(22) Filed: Dec. 10, 2025

Related U.S. Application Data
(63) Continuation of application No. PCT/US24/54420, filed on Nov. 4, 2024.
(60) Provisional application No. 63/595,754, filed on Nov. 3, 2023.
(60) Provisional application No. 63/616,529, filed on Dec. 30, 2023.
(60) Provisional application No. 63/562,244, filed on Mar. 6, 2024.
(60) Provisional application No. 63/631,932, filed on Apr. 9, 2024.

(51) Int. Cl. G06F 40/166; G06F 40/40

(52) U.S. Cl. CPC G06F 40/166; G06F 40/40

(57) ABSTRACT

Embodiments of the present disclosure advantageously provide a computer-based documentation generation system that generates a document from individual outline summaries. In certain embodiments, a documentation generation computer sends a GUI to a client computer for presentation to a user. The GUI includes a document outline region and a dialog region. The document outline region includes outline sections that are selectable by a user. The dialog region includes an input section and an output section. The input section is configured to receive natural language text from the user, and the output section is configured to present information generated by section chat modules that are associated with the outline sections. Each section chat module develops and generates a respective summary outline by interacting with the user and with a large language model (LLM), such as a generative pre-trained transformer (GPT).

### CROSS-REFERENCE TO RELATED APPLICATIONS

This application is a continuation of PCT Application No. PCT/US24/54420 (filed on Nov. 4, 2024) which claims the benefit of U.S. Provisional Application Ser. Nos. 63/595,754 (filed on Nov. 3, 2023), 63/616,529 (filed on Dec. 30, 2023), 63/562,244 (filed on Mar. 6, 2024), and 63/631,932 (filed on Apr. 9, 2024), the contents of which are incorporated by reference herein in their entireties.

### BACKGROUND

The present disclosure relates to document generation, and more particularly, computer-based document generation.

### SUMMARY

In certain embodiments, a document generation computer includes a memory and a processor. The memory is configured to store a graphical user interface (GUI), outline modules, and section chat modules. The GUI includes a document outline region and a dialog region. The document outline region includes outline sections that are selectable by a user, and the outline sections are configured to present information generated by outline modules that are associated with the outline sections. The dialog region includes an input section and an output section. The input section is configured to receive natural language text from the user, and the output section is configured to present information generated by section chat modules that are associated with the outline sections.

The processor is configured to send the GUI to a client computer over a network for presentation to the user; receive outline section selections and natural language text from the client computer over the network; in response to receiving outline section selections and the natural language text, generate outline summaries for the outline sections using the section chat modules, the natural language text, and a large language model (LLM); send the outline summaries to the client computer for presentation to the user; generate a document based on the outline summaries; and send the document to the client computer over the network.

### BRIEF DESCRIPTION OF THE DRAWINGS

FIG. 1 depicts a block diagram of document generation system 100, in accordance with embodiments of the present disclosure.

FIG. 2 depicts a block diagram of document generation computer 200, in accordance with embodiments of the present disclosure.

FIG. 3 depicts an information flow diagram for document generation system 100, in accordance with embodiments of the present disclosure.

FIG. 4 depicts a flow diagram illustrating functionality associated with generating a document, in accordance with embodiments of the present disclosure.

FIG. 5 depicts a GUI for generating an example target product profile (TPP) document, in accordance with embodiments of the present disclosure.

FIGS. 6A to 6L depicts the GUI of FIG. 5 with a first selected outline section, in accordance with embodiments of the present disclosure.

FIG. 7 depicts the GUI of FIG. 5 with a second selected outline section, in accordance with embodiments of the present disclosure.

FIG. 8 depicts the GUI of FIG. 5 with a third selected outline section, in accordance with embodiments of the present disclosure.

FIG. 9 depicts the GUI of FIG. 5 with a fourth selected outline section, in accordance with embodiments of the present disclosure.

FIG. 10 depicts the GUI of FIG. 5 with a fifth selected outline section, in accordance with embodiments of the present disclosure.

### DETAILED DESCRIPTION

Embodiments of the present disclosure advantageously provide a computer-based documentation generation system that generates a document from outline summaries for different sections of the document. The outline summaries are generated using section chat modules, natural language text input by a user, and an LLM.

In certain embodiments, a documentation generation computer sends a GUI to a client computer for presentation to a user. The GUI includes a document outline region and a dialog region. The document outline region includes outline sections that are selectable by a user. The dialog region includes an input section and an output section. The input section is configured to receive natural language text from the user, and the output section is configured to present information generated by section chat modules that are associated with the outline sections. Each section chat module develops and generates a summary outline for the associated outline section by interacting with the user and with an LLM, such as a generative pre-trained transformer (GPT).

More particularly, each section chat module solicits user input in the form of natural language text, prepares prompts for the LLM based on, inter alia, the natural language text and previous LLM responses, receives the LLM responses to the prompts, and generates the summary outline for presentation to the user in the outline region. The document is then generated based on the outline summaries for the outline sections.

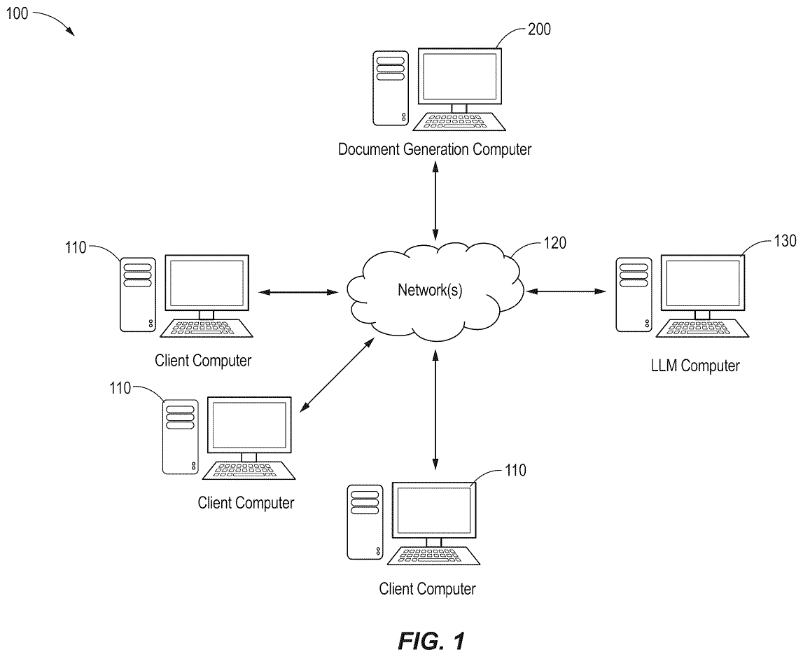

FIG. 1 depicts a block diagram of document generation system 100, in accordance with embodiments of the present disclosure.

In certain embodiments, document generation system 100 includes client computer(s) 110 coupled to network(s) 120, LLM computer 130 coupled to network(s) 120, and documentation generation computer 200 coupled to network(s) 120.

Network(s) 120 may include one or more local area networks, wide area networks, the Internet, etc., which may execute various network protocols, such as, for example, wired and/or wireless Ethernet, Bluetooth, etc. Network(s) 120 may also include various combinations of wired and/or wireless physical layers, such as, for example, copper wire or coaxial cable networks, fiber optic networks, Bluetooth wireless networks, WiFi wireless networks, CDMA, FDMA and TDMA cellular wireless networks, etc.

Documentation generation computer 200 may execute one or more server applications, such as an application server, a web server, an HTTP server, etc., to which client computers 110 may connect through network(s) 120. Generally, documentation generation computer 200 may be a network server, a virtual private server (such as a cloud server), etc. More particularly, documentation generation computer 200 may be configured to execute a document generation application that generates a summary outline for each outline section by interacting with a user's client computer 110 and LLM computer 130, and then generate the document based on the summary outline for each outline section. Documentation generation computer 200 sends the outline summaries and the document to client computer 110 for presentation to the user. The document generation application may include, inter alia, a GUI for transmission to a user's client computer 110, outline modules, section chat modules, a document module, etc.

LLM computer 130 may execute one or more server applications, such as an application server, a web server, an HTTP server, etc., to which documentation generation computer 200 may connect through network(s) 120. Generally, LLM computer 130 may be a network server, a virtual private server (such as a cloud server), etc. More particularly, LLM computer 130 may be configured to execute an LLM, such as a GPT LLM, and service requests (such as prompts) from documentation generation computer 200 using a client-server architecture. LLM computer 130 generates a completion response for each prompt, and sends the completion responses to documentation generation computer 200.

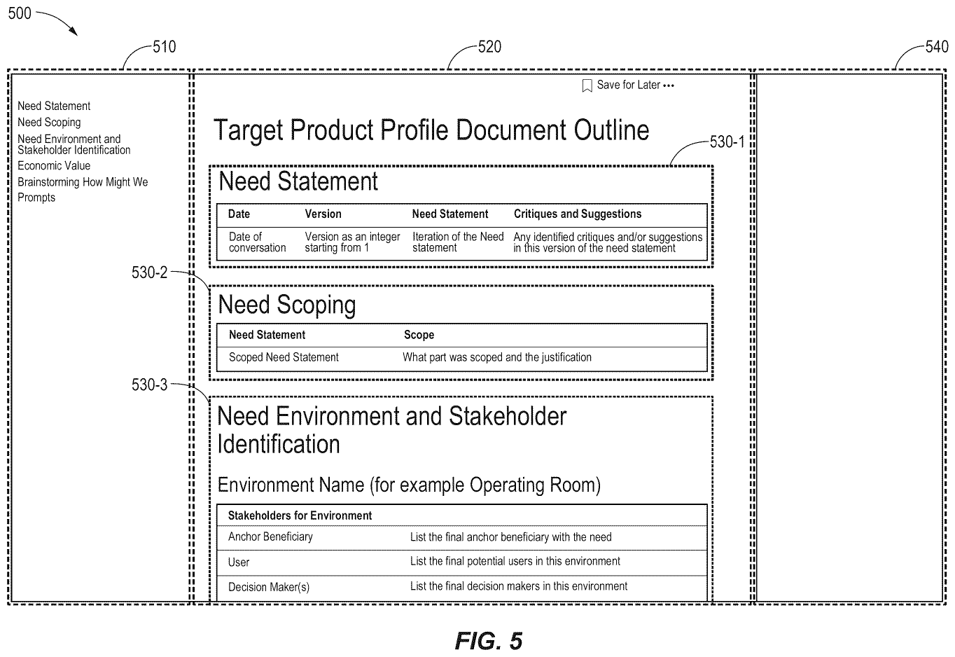

Generally, client computer 110 may be a desktop computer, a laptop computer, a tablet computer, a smartphone, etc. Client computer 110 may request relevant services from, and access relevant applications executed by, documentation generation computer 200, such as a document generation application, using a client-server architecture. More particularly, client computer 110 may present GUI 500 (see FIG. 5-10) received from documentation generation computer 200 to the user (e.g., using a web browser, etc.), receive outline section selections and natural language text from the user, send the outline section selections and natural language text to document generation computer 200, present LLM responses and outline summaries received from document generation computer 200 to the user, and present the document received from document generation computer 200 to the user.

In certain embodiments, the LLM may be hosted by document generation computer 200, and document generation system 100 would not include a separate LLM computer 130. In other embodiments, the document generation application may be hosted by client computer 110, and document generation system 100 would not include a separate document generation computer 200. In certain other embodiments, the document generation application and the LLM may be hosted by a client computer 110, and document generation system 100 would not include a separate documentation generation computer 200 and a separate LLM computer 130.

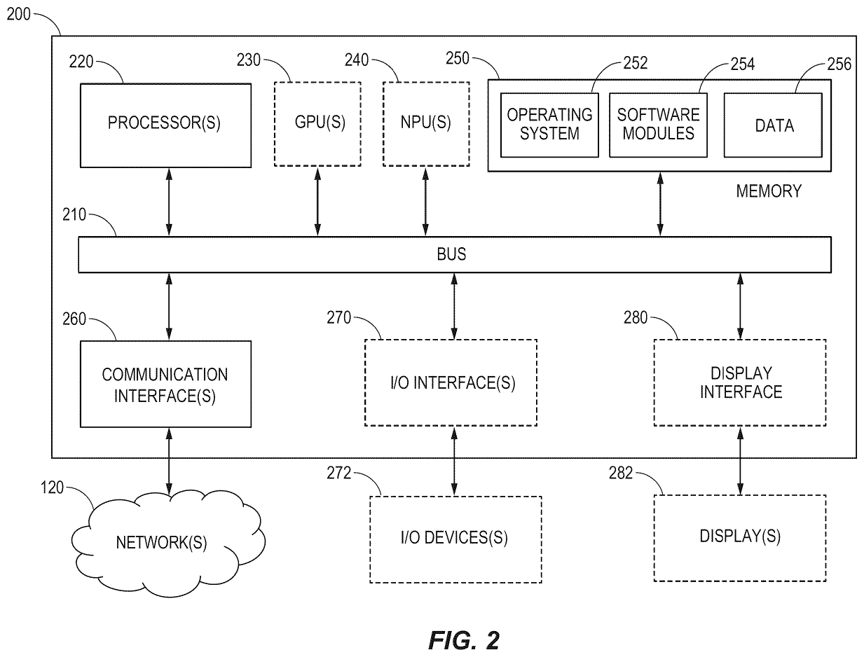

FIG. 2 depicts a block diagram of document generation computer 200, in accordance with embodiments of the present disclosure. Generally, LLM computer 130 may include the same components (or a subset of the components) as document generation computer 200. Similarly, client computer 110 may include the same components (or a subset of the components) as document generation computer 200.

Document generation computer 200 may include one or more single-core or multi-core processors, specialized processors, etc., that are configured to execute a document generation application that includes, inter alia, a GUI for transmission to a user's client computer 110, outline modules, section chat modules, a document module, etc. The document generation application is configured to generate outline summaries for the outline sections based on, inter alia, natural language text input by a user and LLM responses to the user's natural language text input, and to generate the document based on the outline summaries. As noted above, in certain embodiments, document generation computer 200 may also execute the LLM.

More particularly, document generation computer 200 may be coupled to network(s) 120, input/output (I/O) device(s) 272, and display(s) 282. Document generation computer 200 includes bus 210 coupled to processor(s) 220, storage element or memory 250, communication interface(s) 260, I/O interface(s) 270, and display interface 280. In certain embodiments, document generation computer 200 may include one or more specialized processors, such as, for example, graphics processing units (GPUs) 230, neural processing units (NPUs) 240, etc. Generally, communication interface(s) 260 are coupled to network(s) 120 using a wired or wireless connection, I/O interface(s) 270 are coupled to I/O device(s) 272 using a wired or wireless connection, and display interface 280 is typically coupled to display 282 using a wired or wireless connection.

Bus 210 is a communication system that transfers data between processor(s) 220, memory 250, communication interface(s) 260, I/O interface(s) 270, and display interface 280. In certain embodiments, bus 210 also transfers data between these components and GPU(s) 230 and/or NPU(s) 240, as well as other components not depicted in FIG. 2.

Processor(s) 220 include one or more general-purpose or application-specific microprocessors that execute instructions to perform control, computation, input/output, etc. functions for document generation computer 200. Each processor 220 may include a single integrated circuit, such as a micro-processing device, or multiple integrated circuit devices and/or circuit boards working in cooperation to accomplish the appropriate functionality. In addition, processor(s) 220 may execute computer programs or modules, such as operating system 252, software modules 254, etc., stored within memory 250. For example, software modules 254 may include the document generation application that includes a GUI for transmission to a user's client computer 110, outline modules, section chat modules, a document module, etc.

Generally, memory 250 stores instructions for execution by processor(s) 220 as well as data. Memory 250 may include a variety of non-transitory computer-readable medium that may be accessed by processor(s) 220 as well as other components. In various embodiments, memory 250 may include volatile and nonvolatile medium, non-removable medium and/or removable medium. For example, memory 250 may include any combination of random access memory (RAM), dynamic RAM (DRAM), static RAM (SRAM), read only memory (ROM), flash memory, cache memory, and/or any other type of non-transitory computer-readable medium.

Memory 250 contains various components for retrieving, presenting, modifying, and storing data 256. For example, memory 250 stores software modules 254 that provide functionality when executed by processor(s) 220. Operating system 252 provides operating system functionality for document generation computer 200. Software modules 254 provide various functionality, as described above. Data 256 may include data associated with operating system 252, software modules 254, etc.

Communication interface(s) 260 are configured to transmit data to and from network(s) 120 using one or more wired and/or wireless connections. As discussed above, network(s) 120 may include one or more local area networks, wide area networks, the Internet, etc., which may execute various network protocols, such as, for example, wired and/or wireless Ethernet, Bluetooth, etc. Network(s) 120 may also include various combinations of wired and/or wireless physical layers, such as, for example, copper wire or coaxial cable networks, fiber optic networks, Bluetooth wireless networks, WiFi wireless networks, CDMA, FDMA and TDMA cellular wireless networks, etc.

I/O interface(s) 270 are configured to transmit and/or receive data from I/O device(s) 272. I/O interface(s) 270 enable connectivity between processor(s) 220, memory 250 and I/O device(s) 272 by encoding data to be sent from processor(s) 220 or memory 250 to I/O device(s) 272, and decoding data received from I/O device(s) 272 for processor(s) 220 or memory 250. Generally, data may be sent over wired and/or wireless connections. For example, I/O interface(s) 270 may include one or more wired communications interfaces, such as USB, Ethernet, etc., and/or one or more wireless communications interfaces, coupled to one or more antennas, such as WiFi, Bluetooth, cellular, etc.

Generally, I/O device(s) 272 provide input to document generation computer 200 and/or output from document generation computer 200. As discussed above, I/O device(s) 272 are operably connected to document generation computer 200 using a wired and/or wireless connection. I/O device(s) 272 may include a local processor coupled to a communication interface that is configured to communicate with document generation computer 200 using the wired and/or wireless connection. For example, I/O device(s) 272 may include a keyboard, mouse, touch pad, joystick, etc.

Display interface 280 is configured to transmit image data from document generation computer 200 to display(s) 282.

In certain embodiments, document generation computer 200 is not coupled to I/O device(s) 272 or display 282.

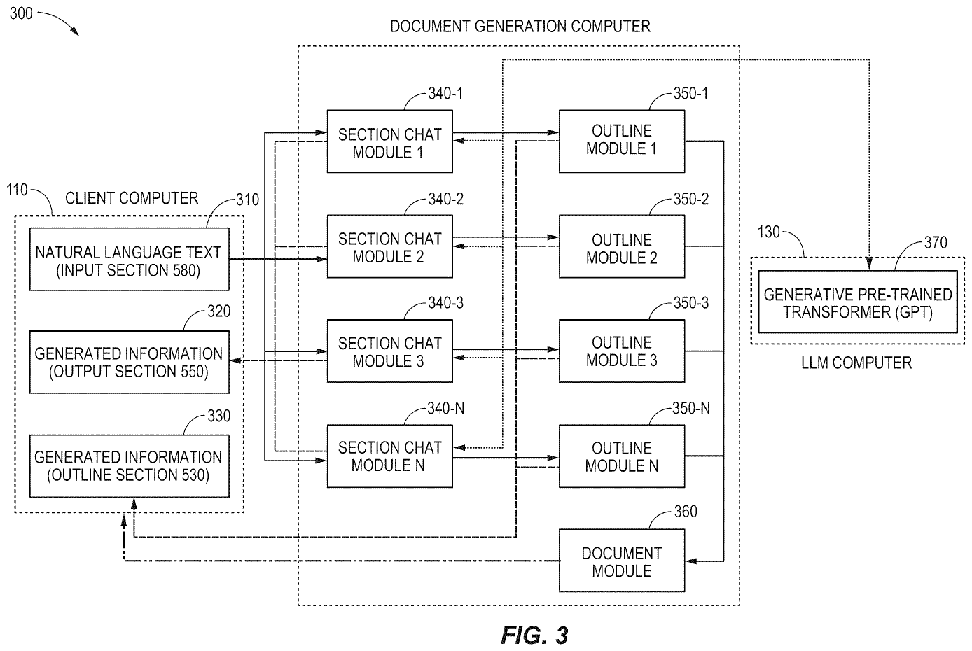

FIG. 3 depicts an information flow diagram 300 for document generation system 100, in accordance with embodiments of the present disclosure.

In certain embodiments, client computer 110 receives GUI 500 (see FIG. 5-10) from document generation computer 200 for presentation on a display to a user. GUI 500 may include index region 510, document outline region 520, and dialog region 540. Index region 510 includes a hyperlink to each selectable outline section 530 in document outline region 520, such as outline sections 530-1, 530-2, 530-3, 530-4, 530-5. Dialog region 540 includes output section 550 and input section 580.

Generally, the flow begins when the user selects an outline section 530 in GUI 500. For example, after outline section 530-1 is selected by the user, section chat module 340-1 generates and provides initial information 552 to output section 550 for display to the user. Input section 580 then receives natural language text 310 from the user (such as a response to the initial information 552), and provides the natural language text 310 to section chat module 340-1 for further processing.

More particularly, section chat module 340-1 generates a prompt for GPT 370 including a section prompt for outline section 530-1 and the natural language text 310, and sends the prompt to LLM computer 130 for processing by GPT 370. GPT 370 generates a completion response based on the prompt, and LLM computer 130 sends the completion response to section chat module 340-1. Section chat module 340-1 generates a response to the natural language text 310 based on the completion response, and sends the response (generated information 320) to client computer 110 for display in output section 550. This chat interaction process is continued until a sufficient amount of information has been received from the user and generated by GPT 370 to create a summary outline for outline section 530-1. In certain embodiments, a notification may be included in the completion response to indicate that the summary outline is ready to be generated.

After a sufficient amount of information has been received from the user and generated by GPT 370, section chat module 340-1 generates a summary outline for outline section 530-1. Section chat module 340-1 sends the summary outline to output section 550 for display to the user, and to outline module 350-1 for further processing. Outline module 350-1 formats the summary outline, and sends the formatted summary outline (generated information 330) to outline section 530-1 for display to the user.

In a similar manner, as each outline section 530-2, 530-3, 530-4, 530-5 is selected by the user, a chat interaction process is established by the respective section chat module 340-2, 340-3, 340-4, 340-5 and continues until a sufficient amount of information has been received from the user and generated by GPT 370 to create a summary outline for that particular outline section 530. When all of the summary outlines have been generated by the section chat modules 340, document module 360 may generate the document based on the summary outlines provided by outline modules 350, and then send the document to client computer 110 for display to the user.

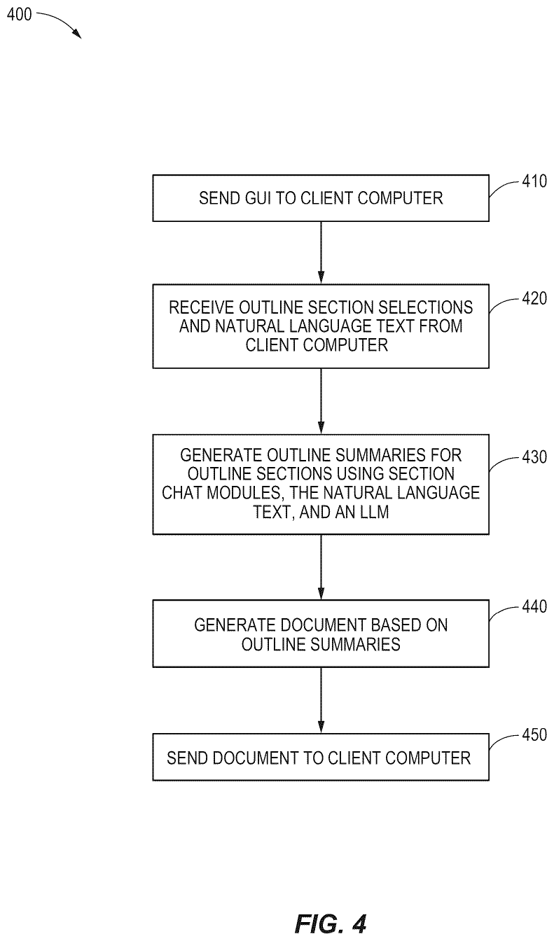

FIG. 4 depicts a flow diagram 400 illustrating functionality associated with generating a document, in accordance with embodiments of the present disclosure. In certain embodiments, document generation computer 200 performs the functionality depicted in flow diagram 400. In other embodiments, client computer 110 may perform the functionality illustrated in flow diagram 400, in which case information is passed as data 256 in memory 250 rather than over network(s) 120.

At 410, GUI 500 is sent to a client computer 110 over network(s) 120 for presentation to a user. GUI 500 includes, inter alia, document outline region 520 and dialog region 540. The document outline region 520 includes outline sections 530 that are selectable by a user, and the outline sections 530 are configured to present information generated by outline modules 350 that are associated with the outline sections 530. Dialog region 540 includes input section 580 and output section 550. Input section 580 is configured to receive natural language text 310 from the user, and output section 550 is configured to present information generated by section chat modules 340 (such as generated information 320) that are associated with the outline sections 530.

At 420, outline section selections and natural language text 310 are received from the client computer 110 over network(s) 120, as described above with respect to information flow diagram 300.

At 430, in response to receiving the outline section selections and the natural language text, outline summaries for outline sections 530 are generated by the section chat modules 340 using the natural language text 310 and an LLM, as described above with respect to information flow diagram 300.

At 440, the outline summaries are sent to the client computer 110 for presentation to the user, as described above with respect to information flow diagram 300.

At 450, a document is generated based on the outline summaries, as described above with respect to information flow diagram 300.

At 460, the document is sent to the client computer 110 over network(s) 120.

FIG. 5 depicts GUI 500 for generating an example TPP document, in accordance with embodiments of the present disclosure. As described above, GUI 500 includes, inter alia, index region 510, document outline region 520, and dialog region 540.

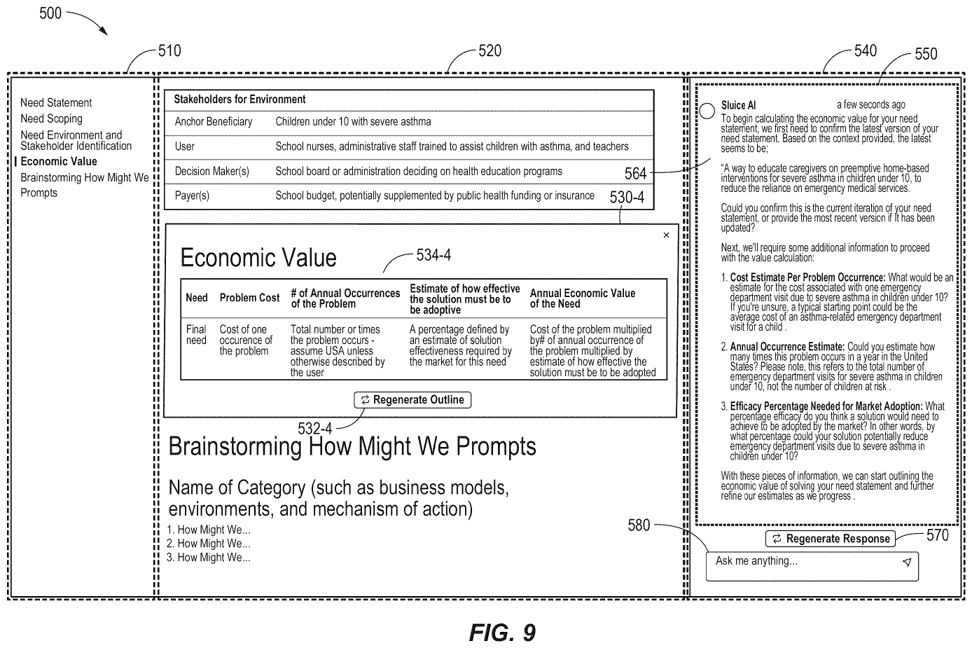

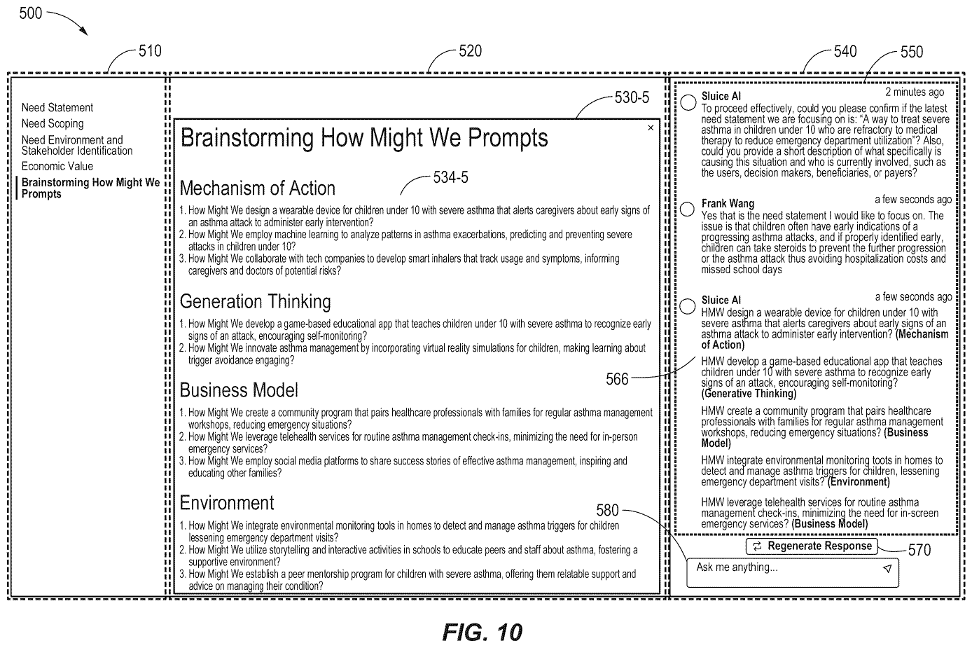

The TPP document includes five outline sections 530 that are arranged within the document outline region 520 and are selectable by a user. Outline section 530-1 is directed to a “Need Statement,” outline section 530-2 is directed to “Need Scoping,” outline section 530-3 is directed to “Need Environment and Stakeholder Identification,” outline section 530-4 (see FIG. 9) is directed to “Economic Value,” and outline section 530-5 (see FIG. 10) is direct to “Brainstorming How Might We Prompts.”

The outline sections 530 are configured to present information generated by outline modules 350 that are associated with the outline sections 530, as described above with respect to information flow diagram 300. Dialog region 540 includes input section 580 and output section 550, which are presented to the user in response to the selection of one of the outline sections 530.

Before each outline section 530 is selected by the user, a default summary outline may be presented to the user for information purposes. For example, outline section 530-1 may present certain details associated with the Need Statement that will be developed by the user through the chat interactions with section chat module 340-1 and the LLM, such as the Need Statement itself, any identified critiques and/or suggestions in the Need Statement, etc.

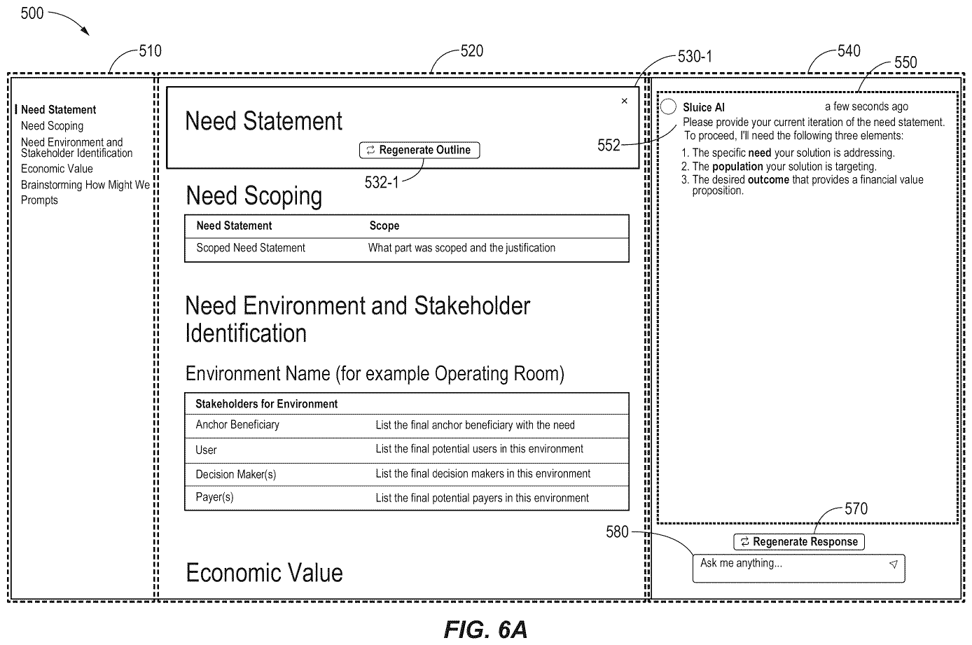

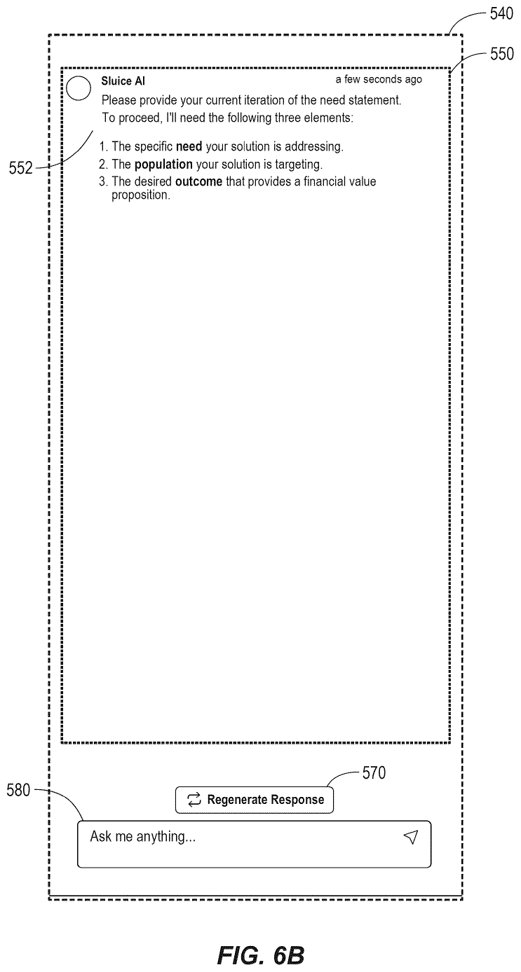

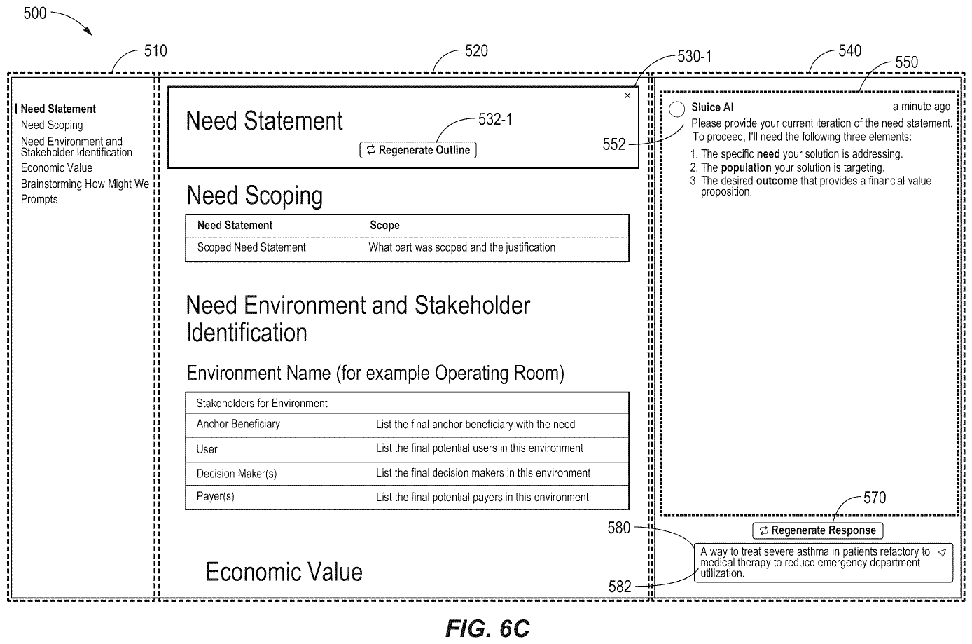

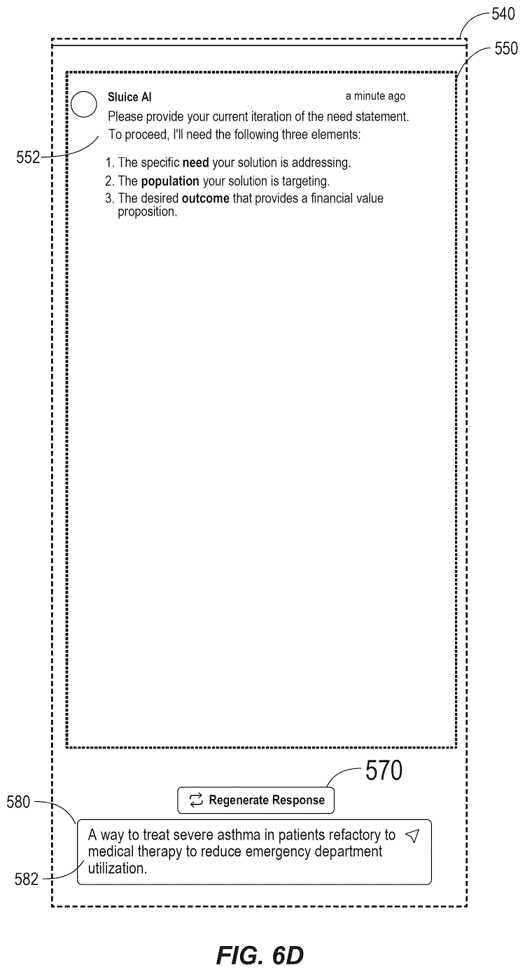

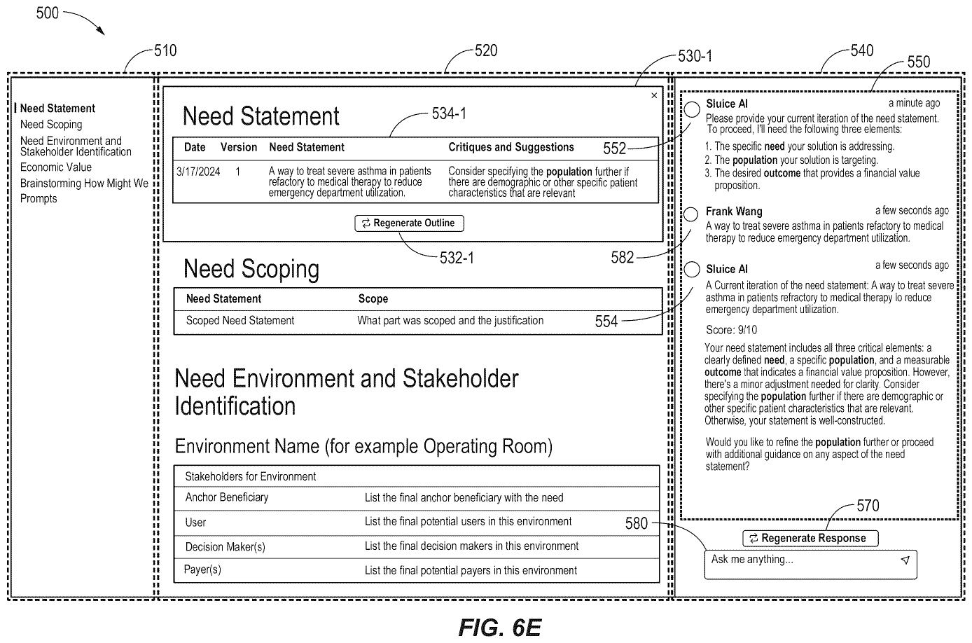

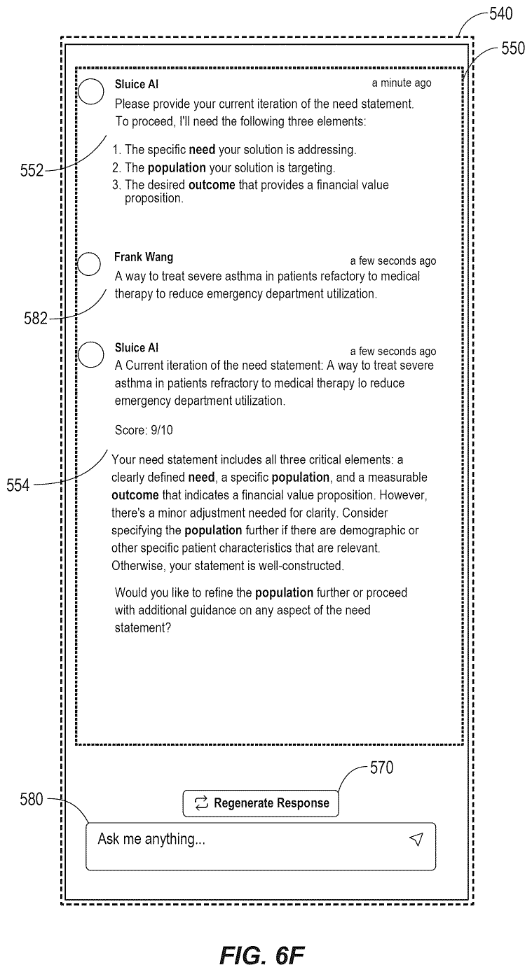

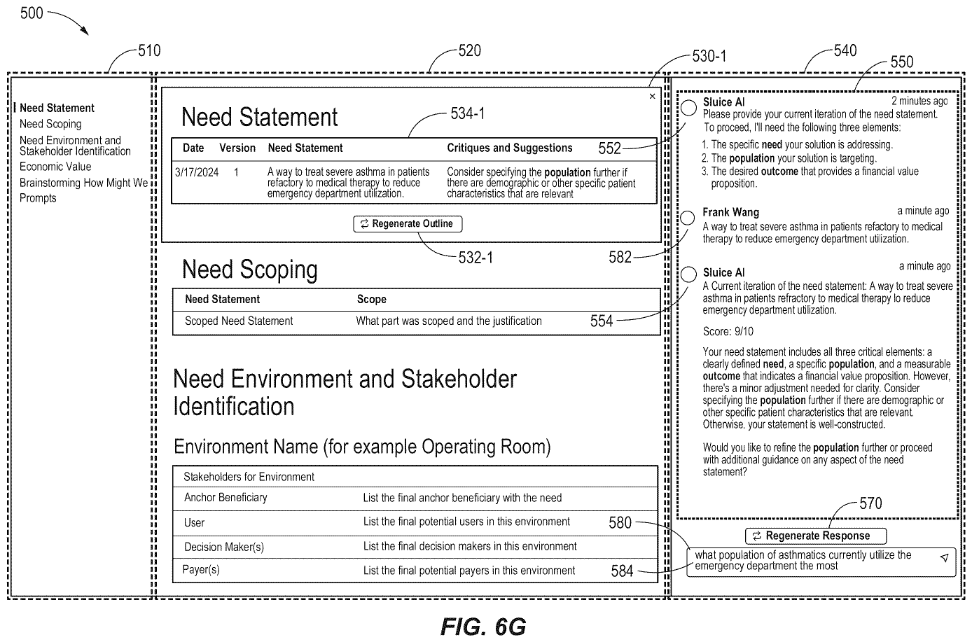

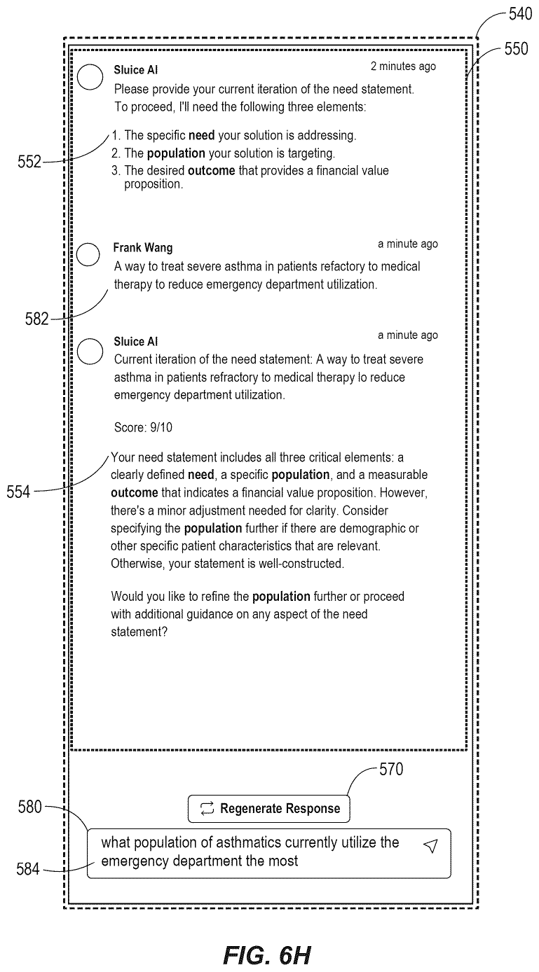

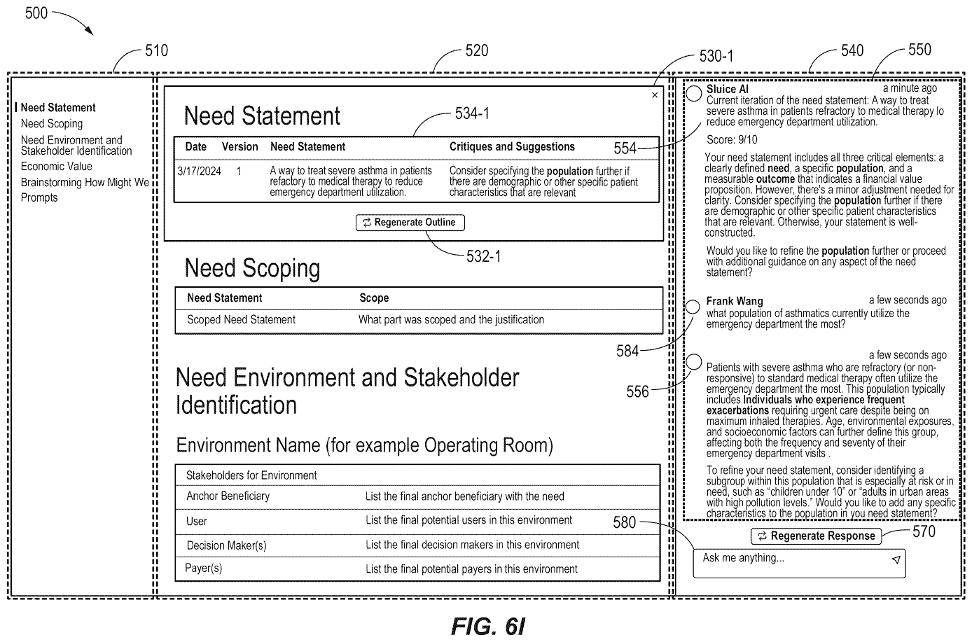

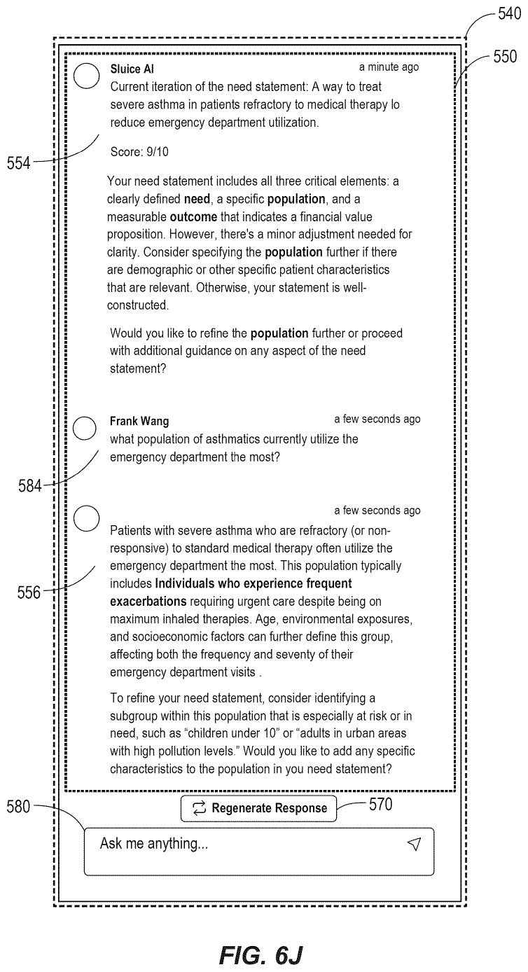

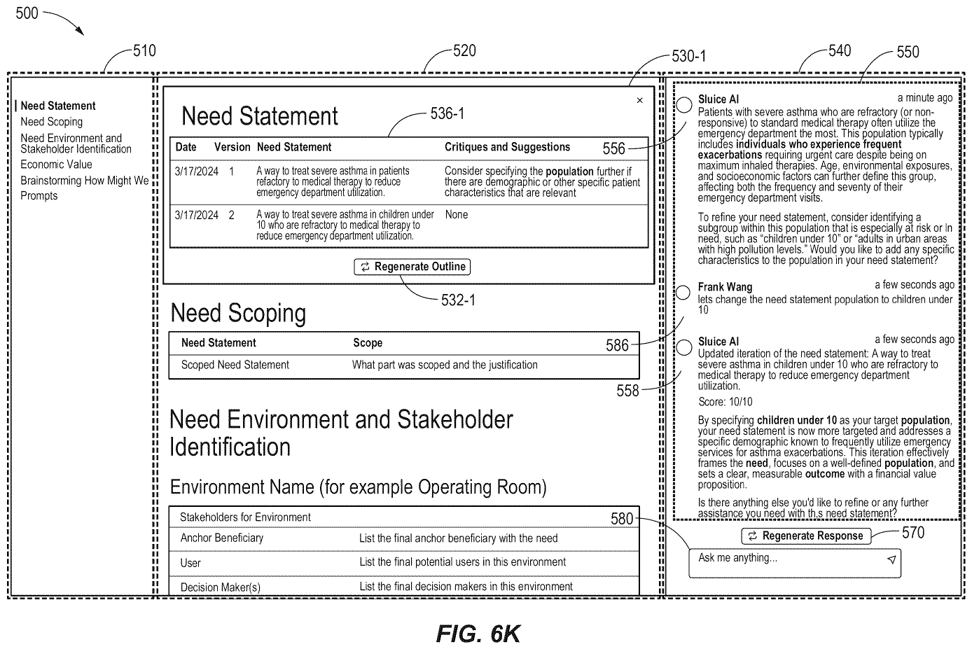

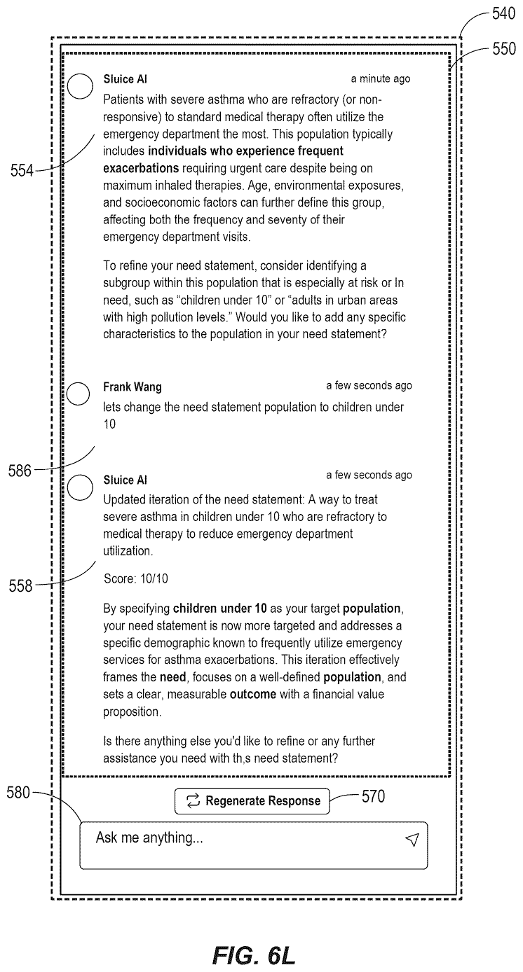

FIGS. 6A to 6L depicts GUI 500 with selected outline section 530-1, in accordance with embodiments of the present disclosure.

FIG. 6A depicts index region 510, document outline region 520 (showing the selection of outline section 530-1), and dialog region 540. Outline section 530-1 includes regenerate outline widget 532-1 (such as a button, etc.), and dialog region 540 includes output section 550, input section 580, and regenerate response widget 570 (such as a button, etc.). FIG. 6B depicts dialog region 540 in a larger format.

In response to receiving the selection of outline section 530-1 by the user, section chat module 340-1 generates initial information 552, and sends initial information 552 to client computer 110 for display in output section 550.

In certain embodiments, section chat module 340-1 may generate initial information 552 using GPT 370. For example, section chat module 340-1 may generate a prompt for GPT 370 that includes a unique section prompt for the selected outline section, and then send the prompt to LLM computer 130 for processing by GPT 370. Section chat module 340-1 may then generate the initial information 552 based on a completion response from GPT 370 that is received from LLM computer 130. In certain embodiments, the unique section prompt may be stored in memory 250 (such as a prompt database, etc.).

In this example, initial information 552 includes the following text “Please provide your current iteration of the need statement. To proceed, I'll need the following three elements: 1. The specific need your solution is addressing. 2. The population your solution is targeting. 3. The desired outcome that provides a financial proposition.”

Advantageously, initial information 552 outlines the goals of outline section 530-1, and solicits the required information form the user in a sequence of chat interactions. Each chat interaction includes natural language text that is provided by the user and the completion response that is provided by GPT 370. In certain embodiments, the chat interactions may be stored in memory 250 (such as a conversation database, etc.).

FIG. 6C depicts index region 510, document outline region 520 (showing the selection of outline section 530-1), and dialog region 540 including output section 550, input section 580, and regenerate response widget 570. FIG. 6D depicts dialog region 540 in a larger format.

In response to initial information 552, in this example the user has typed in the following natural language text 582:“A way to treat severe asthma in patients refractory to medical therapy to reduce emergency department utilization.” In response to selecting enter widget 581 or the enter key, client computer 110 sends natural language text 582 to document generation computer 200.

In response to receiving natural language text 582, section chat module 340-1 generates a prompt for GPT 370 that includes the unique section prompt for the selected outline section and the natural language text 582, and then sends the prompt to LLM computer 130 for processing by GPT 370. Section chat module 340-1 may then generate the summary outline 554 based on a completion response from GPT 370 that is received from LLM computer 130, and send summary outline 554 to client computer 110 for presentation in output section 550.

Section chat module 340-1 also sends summary outline 554 to outline module 350-1 for reformatting, and outline module 350-1 then sends the reformatted outline summary 534-1 to client computer 110 for presentation to the user in outline section 530-1.

FIG. 6E depicts index region 510, document outline region 520 (showing the selection of outline section 530-1), and dialog region 540 including output section 550, input section 580, and regenerate response widget 570. FIG. 6F depicts dialog region 540 in a larger format.

In this example, summary outline 554 includes the following text “Current iteration of the need statement: A way to treat severe asthma in patients refractory to medical therapy to reduce emergency department utilization. Score 9/10. Your need statement includes all three critical elements: a clearly defined need, a specific population, and a measurable outcome that indicates a financial value proposition. However, there's a minor adjustment needed for clarity. Consider specifying the population further if there are demographic or other specific patient characteristics that are relevant. Otherwise, your statement is well constructed. Would you like to refine the population further or proceed with additional guidance on any aspect of the need statement?”

Advantageously, summary outline 554 notes that the current needs statement, while satisfying the requirements of the outline section, may be further refined, offers a suggestion to the user, and solicits whether the user would like to explore the suggested refinement.

Initial information 552, natural language text 582, and summary outline 554 are presented in output section 550, and reformatted outline summary 534-1 is presented in outline section 530-1.

FIG. 6G depicts index region 510, document outline region 520 (showing the selection of outline section 530-1), and dialog region 540 including output section 550, input section 580, and regenerate response widget 570. FIG. 6H depicts dialog region 540 in a larger format.

In response to summary outline 554, in this example the user has typed in the following natural language text 584:“What population of asthmatics currently utilize the emergency department the most?” In response to selecting enter widget 581 or the enter key, client computer 110 sends natural language text 584 to document generation computer 200.

Advantageously, rather than iterate the needs statement, the user has asked a question related to the suggested refinement offered by summary outline 554, which is then processed by section chat module 340-1. In response to receiving natural language text 584, section chat module 340-1 generates a prompt for GPT 370 that includes the unique section prompt for the selected outline section, the natural language text 582, the previous LLM completion response, and natural language text 584, and then sends the prompt to LLM computer 130 for processing by GPT 370. Section chat module 340-1 may then generate response 556 based on a completion response from GPT 370 that is received from LLM computer 130, and send response 556 to client computer 110 for presentation in output section 550. Note that the summary outline 554 and reformatted summary outline 534-1 have not changed.

FIG. 6I depicts index region 510, document outline region 520 (showing the selection of outline section 530-1), and dialog region 540 including output section 550, input section 580, and regenerate response widget 570. FIG. 6J depicts dialog region 540 in a larger format.

In this example, response 556 includes the following text “Patients with severe asthma who are refractory (or non-responsive) to standard medical therapy often utilize the emergency department the most. This population typically includes individuals who experience frequent exacerbations requiring urgent care despite being on maximum inhaled therapies. Age, environmental exposures, and socioeconomic factors can further define this group, affecting both the frequency and severity of their emergency department visits. To refine your need statement, consider identifying a subgroup within this population that is especially at risk or in need, such as ‘children under 10’ or ‘adults in urban areas with high pollution levels.’ Would you like to add any specific characteristics to the population in your need statement?”

Advantageously, response 556 answers the user's question, and offers a suggestion to the user based on its own answer, and solicits whether the user would like to add any specific characteristics to the population.

Summary outline 554, natural language text 584, and response 556 are presented in output section 550, while reformatted outline summary 534-1 is presented in outline section 530-1.

FIG. 6K depicts index region 510, document outline region 520 (showing the selection of outline section 530-1), and dialog region 540 including output section 550, input section 580, and regenerate response widget 570. FIG. 6L depicts dialog region 540 in a larger format.

In response to response 556, in this example the user has typed in the following natural language text 586:“Let's change the need statement population to children under 10.” In response to selecting enter widget 581 or the enter key, client computer 110 sends natural language text 586 to document generation computer 200.

In response to receiving natural language text 586, section chat module 340-1 generates a prompt for GPT 370 that includes the unique section prompt for the selected outline section, natural language texts 582, 584, 586 and the previous LLM completion responses, and then sends the prompt to LLM computer 130 for processing by GPT 370. Section chat module 340-1 may then generate the updated summary outline 558 based on a completion response from GPT 370 that is received from LLM computer 130, and send updated summary outline 558 to client computer 110 for presentation in output section 550.

Summary outline 558 includes the following text: “Updated iteration of the need statement: A way to treat severe asthma in children under 10 who are refractory to medical therapy to reduce emergency department utilization. Score 10/10. By specifying children under 10 as your target population, your need statement is now more targeted and addresses a specific demographic known to frequently utilize emergency services for asthma exacerbations. This iteration effectively frames the need, focuses on a well-defined population, and sets a clear, measurable outcome with a financial value proposition. Is there anything else you'd like to refine or any further assistance you need with this need statement?”

Section chat module 340-1 also sends the updated summary outline 558 to outline module 350-1 for reformatting, and outline module 350-1 then sends the reformatted updated outline summary 536-1 to client computer 110 for presentation to the user in outline section 530-1. Reformatted updated outline summary 536-1 includes information from both summary outline 558 and updated summary outline 558.

Selection of regenerate response widget 570 by the user causes section chat module 340-1 to regenerate the last response, for example, by generating a prompt for GPT 370 that includes the unique section prompt for the selected outline section, the previous natural language texts and the previous LLM completion responses, and then sending the prompt to LLM computer 130 for processing by GPT 370. Section chat module 340-1 then generates a regenerated summary outline based on a completion response from GPT 370 that is received from LLM computer 130, and sends the regenerated summary outline to client computer 110 for presentation in output section 550.

Section chat module 340-1 also sends the regenerated summary outline to outline module 350-1 for reformatting, and outline module 350-1 then sends the reformatted regenerated outline summary to client computer 110 for presentation to the user in outline section 530-1.

Selection of regenerate outline widget 532-1 by the user causes outline module 350-1 to regenerate the last summary outline, for example, by reformatting the previous summary outlines, and sending the reformatted regenerated summary to client computer 110 for presentation to the user in outline section 530-1.

The remaining outline sections 530-2, 530-3, 530-4, 530-5 are processed in a similar manner, with the subject matter varying between outline sections. Importantly, changes to the summary outline in one outline section may impact the summary outline in another section. Accordingly, section chat modules 340 may communicate these changes to one another, through notifications, etc., so that the relevant summary outlines may be updated without user interaction.

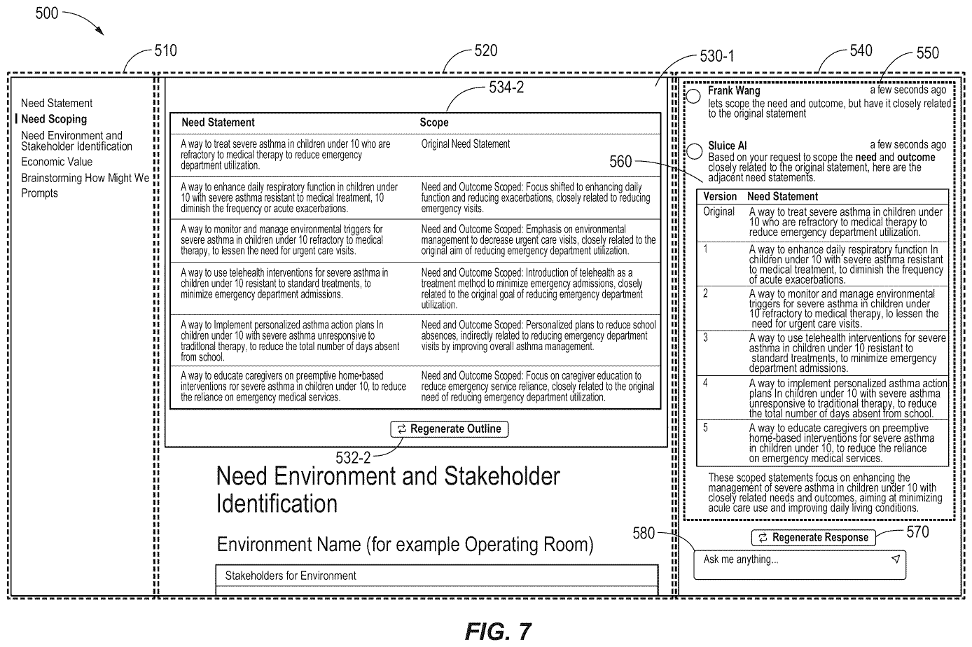

FIG. 7 depicts GUI 500 with selected outline section 530-2, in accordance with embodiments of the present disclosure.

More particularly, FIG. 7 depicts index region 510, document outline region 520 (showing the selection of outline section 530-2), and dialog region 540. Outline section 530-2 includes regenerate outline widget 532-2 (such as a button, etc.), and dialog region 540 includes output section 550, input section 580, and regenerate response widget 570 (such as a button, etc.).

For example, outline section 530-2 may present certain details associated with the Need Scoping that will be developed by the user through the chat interactions with section chat module 340-2 and the LLM, such as the Need Scoping itself, any identified critiques and/or suggestions in the Need Scoping, etc.

As depicted in FIG. 7, the requirements of outline section 530-2 have been met through previous chat interactions with the user. Output section 550 depicts summary outline 560, and outline section 530-2 depicts reformatted summary outline 534-2.

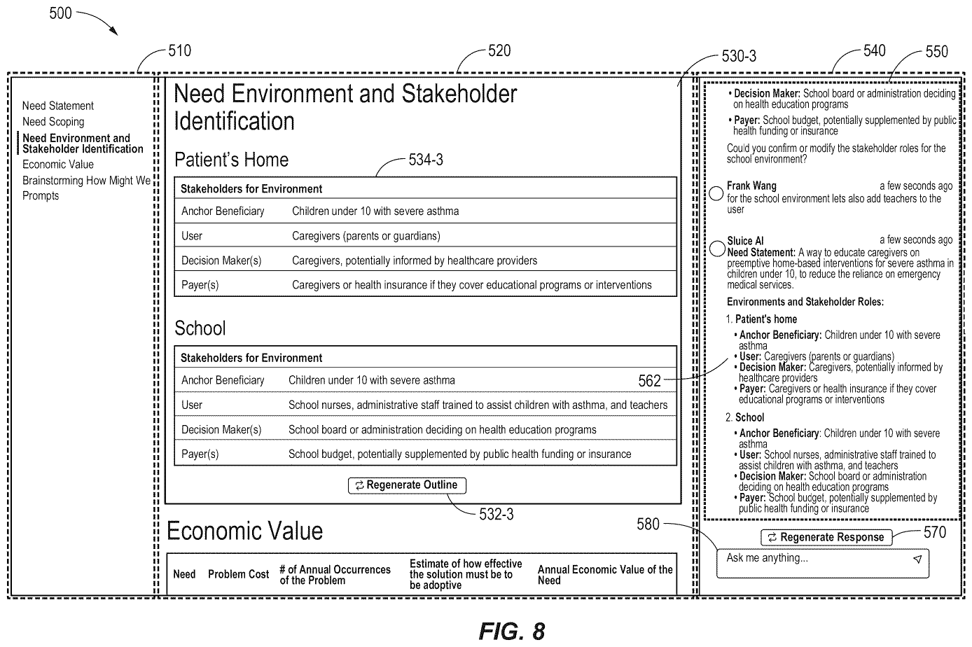

FIG. 8 depicts GUI 500 with selected outline section 530-3, in accordance with embodiments of the present disclosure.

More particularly, FIG. 8 depicts index region 510, document outline region 520 (showing the selection of outline section 530-3), and dialog region 540. Outline section 530-3 includes regenerate outline widget 532-3 (such as a button, etc.), and dialog region 540 includes output section 550, input section 580, and regenerate response widget 570 (such as a button, etc.).

For example, outline section 530-3 may present certain details associated with the Need Environment and Stakeholder Identification that will be developed by the user through the chat interactions with section chat module 340-3 and the LLM, such as the Need Environment and Stakeholder Identification itself, any identified critiques and/or suggestions in the Need Environment and Stakeholder Identification, etc.

As depicted in FIG. 8, the requirements of outline section 530-3 have been met through previous chat interactions with the user. Output section 550 depicts summary outline 562, and outline section 530-3 depicts reformatted summary outline 534-3.

FIG. 9 depicts GUI 500 with selected outline section 530-4, in accordance with embodiments of the present disclosure.

More particularly, FIG. 9 depicts index region 510, document outline region 520 (showing the selection of outline section 530-3), and dialog region 540. Outline section 530-3 includes regenerate outline widget 532-3 (such as a button, etc.), and dialog region 540 includes output section 550, input section 580, and regenerate response widget 570 (such as a button, etc.).

For example, outline section 530-3 may present certain details associated with Economic Value that will be developed by the user through the chat interactions with section chat module 340-4 and the LLM, such as the Economic Value itself, any identified critiques and/or suggestions in the Economic Value, etc.

As depicted in FIG. 9, the requirements of outline section 530-3 have not yet been developed through chat interactions with the user. Output section 550 depicts default summary outline 564, and outline section 530-4 depicts reformatted default summary outline 534-4.

FIG. 10 depicts GUI 500 with selected outline section 530-5, in accordance with embodiments of the present disclosure.

More particularly, FIG. 10 depicts index region 510, document outline region 520 (showing the selection of outline section 530-3), and dialog region 540. Outline section 530-5 includes regenerate outline widget 532-5 (such as a button, etc.), and dialog region 540 includes output section 550, input section 580, and regenerate response widget 570 (such as a button, etc.).

For example, outline section 530-5 may present certain details associated with Brainstorming How Might We Prompts that will be developed by the user through the chat interactions with section chat module 340-5 and the LLM, such as the Brainstorming How Might We Prompts itself, any identified critiques and/or suggestions in Brainstorming How Might We Prompts, etc.

As depicted in FIG. 10, the requirements of outline section 530-5 have been met through previous chat interactions with the user. Output section 550 depicts summary outline 566, and outline section 530-5 depicts reformatted summary outline 534-5.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A computer-based method for generating a document, comprising:
sending, to a client computer, a graphical user interface (GUI) for presentation to a user, the GUI including a document outline region and a dialog region, wherein:
the document outline region includes outline sections that are selectable by a user, and the outline sections are configured to present information generated by outline modules that are associated with the outline sections, and
the dialog region includes an input section and an output section, the input section is configured to receive natural language text from the user, and the output section is configured to present information generated by section chat modules that are associated with the outline sections;
generating, by a section chat module, initial information associated with a selected outline section received from the client computer;
sending, to the client computer, the initial information for display in the output section;
receiving, from the client computer, natural language text associated with the initial information;
generating, by the section chat module, a response to the natural language text, including:
generating a prompt for a large language model (LLM), the prompt including a section prompt for the selected outline section and the natural language text,
sending the prompt to the LLM, and
generating the response based on a completion response received from the LLM; and
sending, to the client computer, the response for display in the output section of the dialog region.

2. The computer-based method according to claim 1, further comprising:
storing the natural language text and the completion response as a chat interaction for the selected outline section in a memory.

3. The computer-based method according to claim 2, further comprising:
receiving, from the client computer, additional natural language text associated with the response;
generating, by the section chat module, an additional response to the additional natural language text, including:
generating an additional prompt for the LLM, the additional prompt including the section prompt, previous chat interactions for the selected outline section, and the additional natural language text,
sending the additional prompt to the LLM, and
generating the additional response based on an additional completion response received from the LLM; and
sending, to the client computer, the additional response for display in the output section of the dialog region.

4. The computer-based method according to claim 3, further comprising:
storing the additional natural language text and the additional completion response as an additional chat interaction for the selected outline section in the memory.

5. The computer-based method according to claim 4, further comprising:
detecting, by the section chat module, a keyword within the additional completion response;
generating, by the section chat module, a summary outline for the selected outline section, including:
generating a further prompt for the LLM, the further prompt including an outline prompt and previous chat interactions for the selected outline section,
sending the further prompt to the LLM, and
generating the summary outline based on a further completion response received from the LLM; and
sending, to the client computer, the summary outline for display in the output section of the dialog region and the selected outline section of the document outline region.

6. The computer-based method according to claim 5, further comprising:
storing the summary outline in the memory.

7. The computer-based method according to claim 6, wherein:
the prompt, the additional prompt, and the further prompt further include a summary outline for each outline section.

8. The computer-based method according to claim 7, wherein the dialog region includes a regenerate response widget, and the method further comprises:
in response to receiving a selection of the regenerate response widget by the user, generating, by the section chat module, a new response based on the section prompt and prior chat interactions for display in the output section of the dialog region.

9. The computer-based method according to claim 7, wherein each outline section includes a regenerate outline widget, and the method further comprises:
in response to receiving a selection of the regenerate outline widget by the user, generating, by an outline module, a new summary outline based on the initial information, prior natural language text, and prior responses for display in the selected outline section.

10. The computer-based method according to claim 7, wherein the document outline region includes a generate document widget, and the method further comprises:
in response to receiving a selection of the generate document widget by the user:
generating, by a document module, a document based on the summary outline for each outline section, and
sending the document to the client computer.

11. The computer-based method according to claim 10, wherein the document is a business plan, and the outline sections include a need statement section, a need scoping section, a need environment and stakeholder identification section, an economic value section, and a brainstorming section.

12. The computer-based method according to claim 1, wherein the GUI further includes an index region that includes a hyperlink to each outline section.

13. The computer-based method according to claim 1, wherein the LLM is a generative pre-trained transformer.

14. The computer-based method according to claim 1, wherein the initial information includes a list of document requirements associated with the selected outline section.

15. A computer, comprising:
a memory configured to store a graphical user interface (GUI), outline modules, and section chat modules, the GUI including a document outline region and a dialog region, wherein:
the document outline region includes outline sections that are selectable by a user, and the outline sections are configured to present information generated by outline modules that are associated with the outline sections, and
the dialog region includes an input section and an output section, the input section is configured to receive natural language text from the user, and the output section is configured to present information generated by section chat modules that are associated with the outline sections; and
a processor coupled to the memory and a network, the processor configured to:
send, to a client computer, the GUI for presentation to the user,
generate, by a section chat module, initial information associated with a selected outline section received from the client computer;
send, to the client computer, the initial information for display in the output section;
receive, from the client computer, natural language text associated with the initial information;
generate, by the section chat module, a response to the natural language text, including:
generate a prompt for a large language model (LLM), the prompt including a section prompt for the selected outline section and the natural language text,
send the prompt to the LLM, and
generate the response based on a completion response received from the LLM; and
send, to the client computer, the response for display in the output section of the dialog region.

16. A computer-based method for generating a document, the method comprising:
sending, to a client computer over a network, a graphical user interface (GUI) for presentation to a user, the GUI including a document outline region and a dialog region, wherein:
the document outline region includes outline sections that are selectable by a user, and the outline sections are configured to present information generated by outline modules that are associated with the outline sections, and
the dialog region includes an input section and an output section, the input section is configured to receive natural language text from the user, and the output section is configured to present information generated by section chat modules that are associated with the outline sections; and
receiving outline section selections and natural language text from the client computer over the network;
in response to receiving the outline section selections and the natural language text, generating outline summaries for the outline sections using the section chat modules, the natural language text, and a large language model (LLM);
sending the outline summaries to the client computer for presentation to the user;
generating a document based on the outline summaries; and
sending the document to the client computer over the network.
